(19) United States
(12) Patent Application Publication
(10) Pub. No.: US 2020/0160409 A1
(43) Pub. Date: May 21, 2020

(54) SYSTEM AND METHOD RELATED TO A FAMILY AND FUNERAL HOME ASSISTANCE PROGRAM

(71) Applicant: Scott L. Lyons, Palm Bay, FL (US)

(72) Inventor: Scott L. Lyons, Palm Bay, FL (US)

(21) Appl. No.: 16/689,039

(22) Filed: Nov. 19, 2019

Related U.S. Application Data
(60) Provisional application No. 62/769,073, filed on Nov. 19, 2018.

(51) Int. Cl. G06Q 30/02; G06Q 20/20; G06Q 20/32

(52) U.S. Cl. CPC G06Q 30/0279; G06Q 20/3276; G06Q 20/209

(57) ABSTRACT

A method for making donations on behalf of a decedent. A donor receives a list of decedent-preferred charities, selects a charity from the list, contacts a selected charity on the list, makes a donation to the selected charity. The charity receives the donation, enters the donor's name on a donor list, aggregates the donations made on behalf of the decedent, and supplies a funeral home with a list of donors and an aggregate contribution of all donations made on behalf of the decedent. A keepsake card is prepared for the family of the decedent. The card has a first field indicating a name of the decedent, a second field indicating the aggregate contribution of all donations made on behalf of the decedent to the charity, and a third field indicating a name of the donor.

### CROSS REFERENCE TO RELATED APPLICATIONS

The present application claims the benefit under Section 119(e) of the provisional application filed on Nov. 19, 2018 and assigned application number 62/769073.

### FIELD OF THE INVENTION

The present invention relates to a system and method of a family and funeral home donation assistance program in which family and friends of the decedent can make contributions to a charitable organization. The system tracks the contributions and generates a list of donors for the decedent's next of kin. The system and method can also be applied in any situation when a family or an individual has experienced a personal emergency or disaster and donations are made to cover unexpected costs. Importantly, in both cases, the family or individual will be made aware of the donation made on his/her behalf.

### BACKGROUND OF THE INVENTION

As it pertains to funerals, flowers are no longer in vogue. They die quickly and are costly for the funeral home to set up, move to the gravesite, or otherwise dispose of. Today, many funeral homes suggest, or the family requests, that friends of the decedent donate to an appropriate charity, in lieu of flowers. But the donor may never know whether the family of the decedent has been made aware of his donation. Such is not a desirable situation from the donor's perspective. While the donor may not expect to receive a “thank-you” directly from the decedent's family, at a minimum he should be made aware that the family was told of his donation.

Friends may also make a donation directly to the family to help defray funeral expenses. While such donations are appreciated, they may never be acknowledged with a grateful and sincere “thank-you” due to the stresses accompanying a loved one's death and the many unexpected tasks that it generates.

The present invention avoids these issues and problems.

Because cremations now account for about 50% of all funeral services and are projected to increase to about 80% in fifteen years, funeral homes are losing enormous income. The average funeral costs $8,500, and the average cremation costs about $1650. Hence, a very dramatic loss of revenue has already occurred, and will only worsen in the future. To compensate and reduce expenses, many funeral homes now share a hearse and have the embalming/dressing done at a neutral location, as opposed to in-house. Brick and mortar funeral homes are very expensive to staff and maintain; so owners are doing all they can to cut costs.

### BRIEF DESCRIPTION OF THE DRAWINGS

The various advantageous features of the invention will be apparent from the following more particular description of the invention, as illustrated in the accompanying drawings in which like reference characters refer to the same elements throughout the different figures. The figures are not necessarily to scale, emphasis instead being placed upon illustrating the principles of the invention.

FIG. 1 illustrates a system according to one embodiment of the present invention.

FIG. 2 illustrates a flow chart for a method according to the present invention.

FIGS. 3-5 illustrate three exemplary keepsake cards presented to a family member or a friend of the decedent.

FIG. 6 illustrates a kiosk and elements therein according to one embodiment of the invention.

FIG. 7 illustrates a computer system for use in implementing the present invention.

### DETAILED DESCRIPTION OF THE INVENTION

Before describing the method and system of the present invention, it should be observed that the specification describes and the drawings illustrate only those details that are pertinent to understanding the present invention without obscuring the disclosure with structural and functional details that will be apparent to those skilled in the art having the benefit of the description herein.

The following embodiments are not intended to define limits of the structure, function, or method of the invention embodiments, but only to provide exemplary constructions. The embodiments are permissive rather than mandatory and illustrative rather than exhaustive.

To increase funeral home revenue, as well as to relieve families of a financial and time-consuming burden in a time of grief, the present invention relates to an efficient and timely method and system for making donations that honor the decedent. With cooperation of the funeral home, the inventive method and system will encourage donations to the decedent's favorite charity in lieu of flowers. The funeral home providing this system and the system supplier are compensated by a small fee that is added to the donated amount and is paid by the donor. In one embodiment, the charity receives 100% of the donation while the small fee, collected at the time of the donation, is split between the funeral home and the system supplier. For example, if the donor contributes $50, the total charge to the donor is $56, with the $6 fee split between the funeral home and the system supplier.

In one embodiment, a kiosk within the funeral home provides names of charities preferred by the decedent or his/her family. The list can be provided as a printout from a printer in the kiosk or on-screen at a kiosk computer or at another processing device with web-access. The kiosk may be placed near the funeral registry or guest book that visitors sign to memorialize their appearance at the wake.

In another embodiment, a scannable QR code is presented proximate the registry. The donor scans the code with her/his smart phone and is directed to a website through which the donation can be made. Guests attending the wake or service may use these components to immediately make a donation on behalf of the deceased.

As an alternative to use of the kiosk or QR code at the registry, a guest can obtain a paper list of the preferred charities and later access one of the listed charity's web sites to make a contribution. In yet another embodiment, links to the preferred charities can be included on the web site of the funeral home, indexed according to the name of the deceased. Or a link to the charity web sites can be embedded in the deceased's obituary. The objective is to make the donation process easy and efficient for any donor.

At some time after the wake (45 days in one embodiment) when all donations have been made (or are expected to have been made), the system provides the family, as well as the funeral home, with the name of the decedent, the total amount donated to each decedent-preferred charity, and the name of each donor to each charity. This information is provided in the form of a physical remembrance or keepsake, further described below.

Providing this feedback information is hugely significant because more often than not the deceased's family is not aware that a donor has made a donation in remembrance of the deceased. Before the advent of this system, donors did not receive any recognition for their generosity and family members of the decedent were not made aware of the donations made on behalf of the decedent.

The system automatically and instantly thanks the donor after the donation has been made and further advises the donor that the family will be or has been advised of their generous contribution.

In a preferred embodiment the remembrance or keepsake comprises a list of donors and is printed on card stock or another high-quality material and features an attractive border suitable for framing. A photo of the deceased appears on a front surface of the card stock within the border. The list also identifies the receiving charity and multiple lists may be created and provided if donations have been made to multiple charities on behalf of a single decedent. The name of the funeral home and its location(s) are also printed on the keepsake. While identifying a sponsor of the program, printing of the funeral home name also serves as a source of advertising for the funeral home.

In addition, family members receive a keepsake card in which the obituary, lists of donors, etc. can be displayed and stored.

As can now be appreciated, aggregate donations made in the name of a loved one will have a more significant impact than a series of small donations. Also, a monetary donation can have a longer lasting effect than a perishable item, such as a floral arrangement. During a time of grief, most families want to say “thank you”, but immediately after losing a loved one is often not the best time for them to undertake that effort. Thus, the system of the invention provides a “thank-you,” albeit a bit impersonal. The system also supplies contact information for each donor so that family members can send a personal “thank-you” to the donors.

The remembrance or keepsake provided to the deceased family is a gift of “thank you for your business” from the funeral home. The name and logo of the entity providing these donation services, typically the funeral home, appears on the keepsake. Multiple names and logos can be listed.

Typically, the service provider can charge a small fee per donation. In recognition of the funeral homes' effort and cooperation, the funeral home also receives an agreed-upon amount of the revenue received from each donor.

The system provides a “win” for all involved during the difficult time of the passing of a loved one.

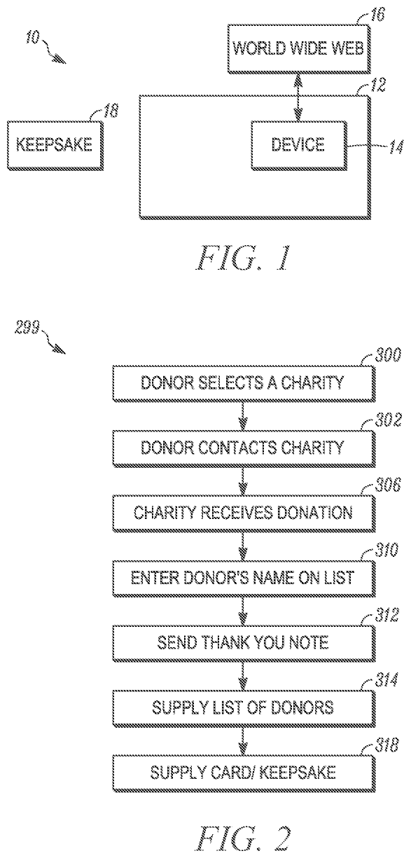

FIG. 1 illustrates a system 10 for implementing one embodiment of the present invention. A user uses a kiosk 12 (preferably located within a funeral home) and a device 14 located therein to make a donation on behalf of a decedent. As shown, the device accesses a world wide web 16, specifically a web site of the funeral home providing burial services for the decedent or an obituary of the decedent. At one of these sites the user enters the name of the decedent and in response the user receives a list of decedent preferred charities. The user selects one of the preferred charities, accesses the web site of the charity, and makes a donation on behalf of the decedent. The donee charity receives the donation and enters the donor's name on a donor list. Later the donee charity aggregates the list of donors and provides the list to the funeral home and/or the decedent's family. As described elsewhere herein, the list is in the form of an attractive keepsake 18 with a photo of the decedent, a name of the funeral home, etc.

FIG. 2 is a flowchart 299 illustrating certain method steps associated with an embodiment of the present invention. At a step 300 a donor selects a charity from among a list of decedent-preferred charities. The list may be present in an obituary of the decedent or on a funeral home web site. At a step 302 the donor contacts a charity on the list by accessing a web site of the charity. Alternatively, the donor can send a check to the charity. The charity receives the donation at a step 306 and enters the donor's name on a donor list at a step 310. The charity sends a thank-you note to the donor at a step 312. Each decedent-preferred charity aggregates the donations received. Then at a step 314 each charity supplies the funeral home with a list of donors and an aggregate contribution of all donors. At a step 318 a keepsake is generated and given to the family. As described elsewhere herein, the keepsake includes the names of the donors to the charity and a sum total of the donations received. Contact information is also supplied to the family in the event a family member wishes to send the donor a personalized “thank-you.”

The inventor is optimistic that the method and system of the present invention will entice people who may not typically make a donation on behalf of a decedent to make such a donation. If the family likely will not be made aware of a donation, the potential donor may simply not bother. However, if the donor can be certain that the family will be made aware of his donation, he is more likely to make the donation.

Note also that according to one embodiment individual donated amounts are not identified. Whether the donor contributes $20 or $10,000 she is identified on the keepsake card presented to the family.

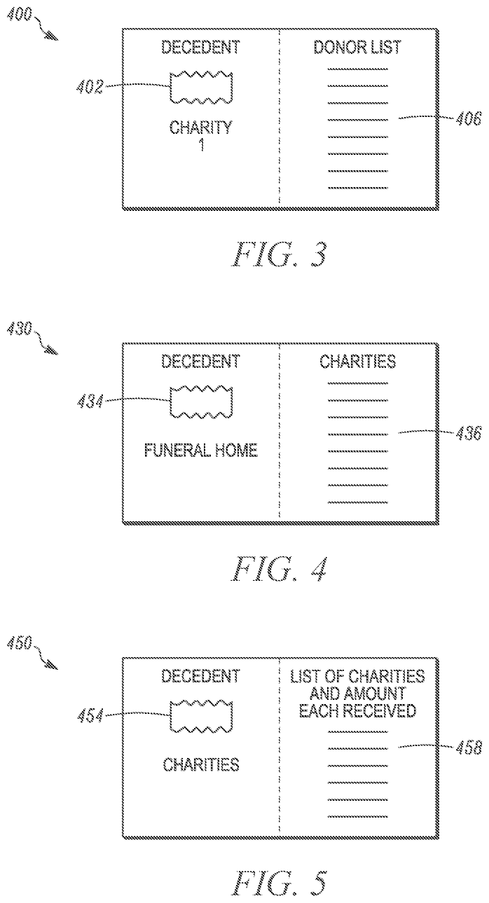

The keepsake card presented to the family can take any one of many forms and include several types of information. FIGS. 3-5 illustrate three exemplary keepsake cards.

FIG. 3 illustrates a physical keepsake card 400 that is given to a family or friend of a decedent. The card bears the name of the decedent and a photo 402. The card is issued by a charity (referred to as Charity 1) receiving donations, and includes a list 406 of donors to Charity 1. The donor list may include the amount donated by each donor or an aggregate amount donated to Charity 1 by all donors. The keepsake card can also be prepared by the funeral home after receiving donation information from the charity, Charity 1 in this illustrated embodiment.

FIG. 4 illustrates a physical card 430 that is given to a family or a friend of the decedent by a funeral home providing the burial services. The card 430 bears the name of the funeral home and a photo 434 of the decedent. The card is issued by the funeral home and includes a list 436 of charities receiving donations on behalf of the decedent. The list may include the amount donated to each listed charity.

FIG. 5 illustrates a physical card 450 that is given to a friend or family member of the decedent. The card 450 bears the name of the decedent and a photo 454. A list 458 sets forth a list of charities receiving donations on behalf of the decedent and the amount each charity received.

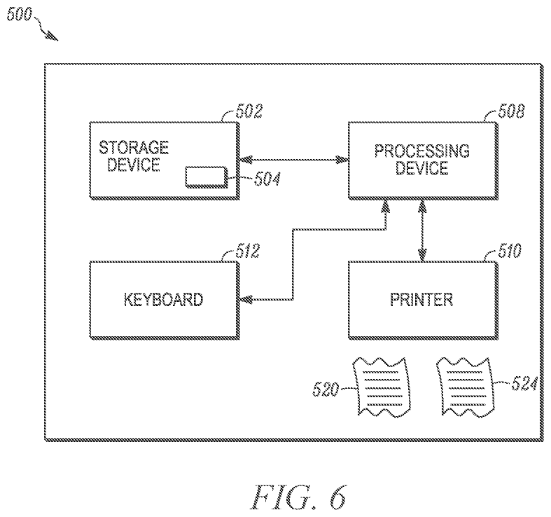

FIG. 6 depicts a kiosk 500 within a funeral home. A storage 502 (storing a program code 504), a processing device 508 connected to the storage device, and a printer 510 and a keyboard 512 connected to the processing device, are disposed within the kiosk 500.

The printer 510 can print a receipt 520 indicating a donor's donation to a charity on a list of decedent-preferred charities and print a keepsake card 524, as described herein.

It can now be appreciated that the present invention provides an improved method and system for making donations and advising parties that the donation has been made, beyond the known processes for making donations in memory of a decedent. These additional elements encourage one to make a donation as he can be assured that the family of the decedent will know of the donation. In today's funeral business the donation processes are helter-skelter—the donor never knows whether the family members of the decedent were made aware of her donation.

The present invention overcomes this disadvantage by offering a structure donation process that ends when a keepsake card bearing the names of the donors and the charity to which each donated is presented to the family of the decedent. Only with such a structured donation process can a donor have confidence that her donation will be known by the family.

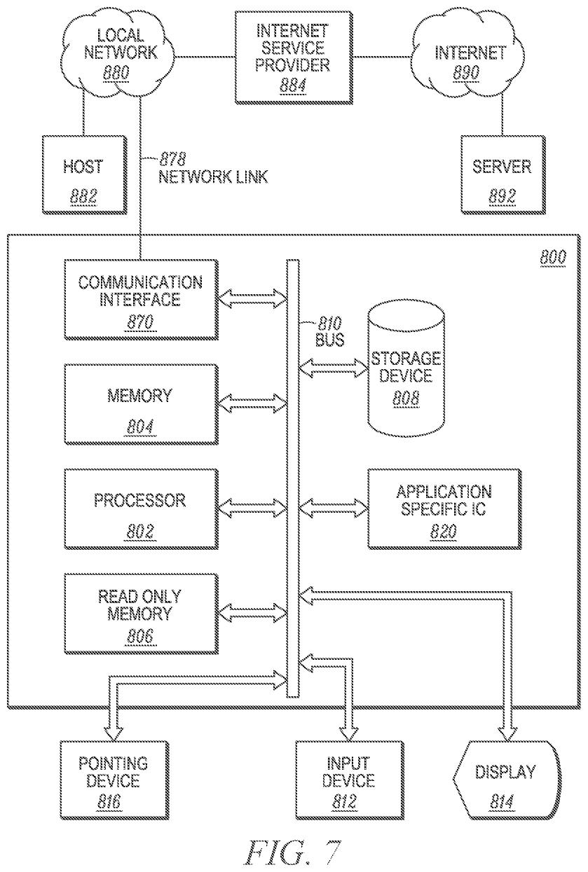

FIG. 7 is a block diagram illustrating a computer system 800 (also referred to as a processing device) upon which embodiments of the invention may be implemented. The computer system 800 includes a communication mechanism such as a bus 810 for passing information between other internal and external components of the computer system 800. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non- zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character.

In some embodiments, information in the form of analog data is represented by a near continuum of measurable values within a particular range. Computer system 800, or a portion thereof, constitutes a means for performing one or more steps of one or more methods described herein.

A sequence of binary digits constitutes digital data that is used to represent a number or code for a character. A bus 810 includes many parallel conductors of information so that information is transferred quickly among devices coupled to the bus 810. One or more processors 802 for processing information are coupled with the bus 810. The processor 802 performs a set of operations on information. The set of operations include bringing information in from the bus 810 and placing information on the bus 810. The set of operations also typically include comparing two or more units of information, shifting positions of units of information, and combining two or more units of information, such as by addition or multiplication. A sequence of operations to be executed by the processor 802 constitute computer instructions.

The computer system 800 also includes a memory 804 coupled to bus 810. The memory 804, such as a random-access memory (RAM) or other dynamic storage device, stores information including computer instructions. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of computer instructions. The computer system 800 also includes a read only memory (ROM) 806 or other static storage device coupled to the bus 810 for storing static information, including instructions, that is not changed by the computer system 800. Also coupled to bus 810 is a non-volatile (persistent) storage device 808, such as a magnetic disk or optical disk, for storing information, including instructions, that persists even when the computer system 800 is turned off or otherwise loses power.

Information, including instructions, is provided to the bus 810 for use by the processor from an external input device 812, such as a keyboard containing alphanumeric keys operated by a human user or a sensor. A sensor detects conditions in its vicinity and transforms those detections into signals compatible with the signals used to represent information in computer system 800. Other external devices coupled to bus 810, used primarily for interacting with humans, include a display device 814, such as a cathode ray tube (CRT) or a liquid crystal display (LCD), for presenting images, and a pointing device 816, such as a mouse or a trackball or cursor direction keys, for controlling a position of a small cursor image presented on the display 814 and issuing commands associated with graphical elements presented on the display 814.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a two-way communication coupling to a variety of external devices that operate with their own processors, such as printers, scanners and external disks. In general, the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated-services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 870 sends and receives electrical, acoustic or electromagnetic signals, including infrared and optical signals, that carry information streams, such as digital data.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 802, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 802, except for carrier waves and other signals.

Logic encoded in one or more tangible media includes one or both of processor instructions on a computer-readable storage media and special purpose hardware, such as ASIC 820.

Network link 878 typically provides information communication through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890. A computer called a server 892 connected to the Internet provides a service in response to information received over the Internet. For example, server 892 provides information representing video data for presentation at display 814.

The invention is related to the use of computer system 800 for implementing the techniques described herein. According to one embodiment of the invention, those techniques are performed by computer system 800 in response to processor 802 executing one or more sequences of one or more instructions contained in memory 804. Such instructions, also called software and program code, may be read into memory 804 from another computer-readable medium such as storage device 808. Execution of the sequences of instructions contained in memory 804 causes processor 802 to perform the method steps described herein. In alternative embodiments, hardware, such as application specific integrated circuit 820, may be used in place of or in combination with software to implement the invention. Thus, embodiments of the invention are not limited to any specific combination of hardware and software.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server 892 transmits program code for a particular application, requested by a message sent from computer 800, through Internet 890, ISP equipment 884, local network 880 and communications interface 870. The received code may be executed by processor 802 as it is received, or may be stored in storage device 808 or other non-volatile storage for later execution, or both. In this manner, computer system 800 may obtain application program code in the form of a signal on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data signal on an infra-red a carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

What is claimed is:

1. A system for processing donations made on behalf of a decedent, the system comprising:
a kiosk located within a funeral home;
within the kiosk a first storage device;
within the kiosk, a first processing device connected to the first storage device;
the first storage device storing a first program for controlling operation of the first processing device;
the first processing device operative with the first program to perform the steps of:
in response to a donor entering a name of the decedent, providing a list of decedent-preferred charities;
in response to the donor selecting a charity from the list, linking to a web site of a selected charity;
in response to the donor selecting a donation amount, providing a donor's donation to the selected charity;
providing a receipt of the donation to the donor;
at the funeral home, a second processing device receiving from the selected charity a list of all donors making a donation to the selected charity and an aggregate amount donated to the selected charity by all donors on behalf of the decedent; and
at the funeral home, a printer for printing a keepsake card including the list of all donors and the aggregate amount donated to the selected charity on behalf of the decedent, the keepsake card for the family of the decedent.

2. The system of claim 1 wherein the keepsake card is provided to family members of the decedent.

3. The system of claim 1 wherein a keepsake card is generated for each decedent-preferred charity on the list of decedent-preferred charities.

4. The system of claim 1 wherein the keepsake card includes a name of the funeral home.

5. The system of claim 1 wherein the first and second processing devices are a same processing device.

6. A system at a funeral home for processing donations made on behalf of a decedent, the system comprising:
a first processing device connected to a first storage device;
the first storage device storing a first program for controlling operation of the first processing device;
the first processing device operative with the first program to perform steps of:
in response to a donor entering a name of the decedent, providing a list of decedent-preferred charities;
in response to the donor selecting a charity from the list, linking to a web site of a selected charity;
in response to the donor selecting a donation amount, providing a donor's donation to the selected charity;
providing a receipt of the donation to the donor;
a list provided to the funeral home by the selected charity, the list comprising a name of each donor making a donation to the selected charity on behalf of the decedent and an aggregate amount donated to the selected charity by all donors on behalf of the decedent; and
a printer for printing a keepsake card including the list.

7. The system of claim 6 wherein the list is included in an obituary of the decedent.

8. A method for making donations on behalf of a decedent and for generating a record of the donations, the method comprising:
a donor receiving a list of decedent-preferred charities;
the donor selecting a charity from the list;
the donor contacting a selected charity on the list;
the donor making a donation to the selected charity;
the selected charity receiving the donation;
the selected charity entering the donor's name on a donor list;
the selected charity aggregating donations made on behalf of the decedent;
the selected charity supplying a funeral home with a list of donors and an aggregate contribution of all donations made on behalf of the decedent; and
preparing a keepsake card having a first field indicating a name of the decedent, a second field indicating the aggregate contribution of all donations made on behalf of the decedent to the selected charity, and a third field indicating a name of the donor.

9. The method of claim 8 wherein a step of the donor receiving the list comprises the donor receiving the list from a family member of the decedent.

10. The method of claim 8 wherein a step of the donor receiving the list comprises a family member providing the list to the funeral home and further comprising the funeral home providing the list to the donor.

11. The method of claim 8 wherein a step of the donor receiving the list comprises embedding the list in an obituary of the decedent or displaying the list on a web site of a funeral home providing burial services for the decedent, and further comprising the donor reading the obituary or reading the list on the web site.

12. Th method of claim 8 wherein the step of the donor contacting the selected charity further comprises the donor accessing a web site of the selected charity.

13. The method of claim 8 wherein a step of the donor making a donation further comprises the donor making the donation through a web site of the selected charity.

14. Executing the method of claim 8 for each charity on the list.

15. The method of claim 8 further comprising presenting the keepsake card to a friend or family member of the decedent.

16. The method of claim 15 wherein the keepsake card list includes contact information of each donor.

17. The method of claim 8 wherein steps of a donor receiving a list of decedent- preferred charities and the donor selecting a charity from the list comprises the donor scanning a QR code with a processing device.

18. A processing device disposed within the funeral home, the processing device comprising instructions for performing the method steps of claim 8.

19. A computer program product comprising a non-transitory computer readable storage media storing a computer program comprising computer executable instructions adapted to, when executed by a computer processor, perform the method according to claim 8.
